(19) United States
(12) Patent Application Publication
(10) Pub. No.: US 2001/0025249 A1
(43) Pub. Date: Sep. 27, 2001

(54) On-line real-time monitoring system and method of on-line real-time monitoring business

(76) Inventor: Daisuke Tokunaga, Tokyo (JP)

Correspondence Address: SUGHRUE, MION, ZINN, MACPEAK & SEAS, 2100 Pennsylvania Avenue, N. W., Washington, DC, 20037, US

(21) Appl. No.: 09/814,944

(22) Filed: Mar. 23, 2001

(30) Foreign Application Priority Data
Mar. 23, 2000 (JP) 2000-082418

(51) Int. Cl. G06F 17/60; G06F 11/30; G21C 17/00

(52) U.S. Cl. 705/10; 702/186; 702/188

(57) ABSTRACT

A monitoring contract with regard to software and/or hardware which are installed in a terminal is concluded by an access from the above-mentioned terminal connectable to a network to a home page set up by a partner of the contract such as makers or information buyers and the like. After concluding the monitoring contract, utilization information with regard to the software and/or the hardware designated as objects of the monitoring contract in the users' terminal is automatically transferred from the above-mentioned terminal to a predetermined node of the partner of the monitoring contract via the above-mentioned network in real time during utilization of the above-mentioned software and/or hardware by a control program accompanying with the above-mentioned monitoring contract distributed by the above-mentioned partner of the contract installed and installed in the above-mentioned terminal. And the payment of the fee as a compensation with respect to the above-mentioned user of the terminal for providing the above-mentioned utilization information is performed by the above-mentioned partner of the contract when predetermined conditions with regard to the monitoring are satisfied.

### BACKGROUND OF THE INVENTION

The present invention relates to a system and a method of monitoring products, and more particularly to a system and a method of monitoring how the software and/or hardware is utilized by users and the like.

Manufacturers (makers) of software or hardware products conducts monitoring to obtain detailed utilization information with regard to how and to which extent the software or the hardware provided by the above-mentioned makers are actually utilized in terminals (computers) on users' side.

Concretely, the makers procure answers from the users by recruiting monitors among the users and using networks such as the Internet and the like, telephones, postcards, FAX (facsimile) and the like. An example of system configuration of a conventional and typical monitoring system is shown in FIG. 8.

Referring to FIG. 8, a conventional monitoring system comprises a terminal 10 of a user 1, a server 20 of a maker 2, a network 100 through which the terminal 10 and the server 20 is connected to each other and other notifying means 50 including telephones, post cards, FAX and the like.

The user 1 concludes a monitoring contract with the maker 2 by accessing a home page set up on the server 20 by the maker 2 through the terminal 10, or by using notifying means 50 of a telephone, a post card, FAX and the like. Later on, the user 1 notifies results of monitoring with respect to the sever 20 by using the network 100 or notifying means 50 of a telephone, a post card, FAX and the like.

The maker 2 makes use of the utilization information of the users as basic information in planning, development and maintenance of the software or the hardware.

However, the above-mentioned conventional monitoring system has a problem as mentioned below.

A first problem is that the conventional monitoring system has a configuration in which the users are responsible for notifying the results of monitoring and provide only insufficient information for grasping details with regard to actual utilization statuses such as,

how the users operate the software or the hardware,

in which part of the software the users feel easy to or hard to use and

how the working condition is.

A second problem is that the utilization information reported by the users is not notified to the maker side in real time. That is, delays are caused in schedules of planning, development, maintenance and the like on the maker side, because a certain extent of monitoring period is provided for the users to report the result of monitoring, after which the users make a report to the maker. And in the event of receiving answers in the form of questionnaire, the answers depend on memories of the users and it is not always possible for the makers to obtain accurate utilization information.

For example, a configuration of a monitoring system is disclosed in unexamined Japanese Patent Publication No. Hei 3-62257, in which each computer collects information about each log-in user and operational processes, and the collected information of self-management are exchanged to each other via a communications medium on request. However, an increase of establishing monitoring contracts, effective transfer of the utilization information in using a designated software and hardware, means for embodying circulations of the utilization information and the like are not considered at all in the above-mentioned unexamined Japanese Patent Publication No. Hei 3-62257.

And, for another example, a proposal is made about a system for grasping the utilization status of the information accurately in the Internet and the like in unexamined Japanese Patent Publication No. Hei 9-282275, in which

an information providing computer transmits information in which a statement for invoking a utilization reporting program is listed to an information receiving computer,

the information receiving computer fetches and executes the utilization reporting program after executing the statements for invoking the program by referring or executing the information and

the information receiving computer transmits data of utilization status of the information including contents about information users, utilizing time, utilizing information and the like by executing the utilization reporting program. Further, for still another example, a proposal is made about a method of collecting the utilization information with regard to services provided by a computer with respect to another computer in unexamined Japanese Patent Publication No. Hei 7-319832, in which

a name of a computer using services provided by a designated computer and information about designated services are collected and

collecting information can be performed by one command execution. However, an increase of establishing monitoring contracts, effective transfer of the utilization information in using a designated software or hardware, recognitions or considerations with regard to circulations of the utilization information and the like are not described at all in the above-mentioned unexamined Japanese Patent Publications and the above-mentioned problems are remained unsolved.

### SUMMARY OF THE INVENTION

In the view of the above-mentioned problems in the conventional systems and methods, it is therefore an object of the present invention to provide a system and a method of online real-time monitoring business and a recording medium capable of obtaining detailed information about utilizations of terminals in real time.

It is another object of the present invention to provide a system and a method of on-line real-time monitoring business and a recording medium capable of reducing the purchase price substantially at a purchase of the product by allowing the user to offer the utilization information for sale.

It is still another object of the present invention to provide a system and a method of on-line real-time monitoring business and a recording medium capable of lightening the work-load for the user in concluding monitoring contract or performing a monitoring and expected to increase the number of monitoring contracts. Other objects, features, advantages and the like of the present invention will become apparent immediately to those skilled in the art from the following description of the preferred embodiments.

The present invention is provided for achieving the above-mentioned objects, in which the utilization information with regard to the above-mentioned software and/or hardware in the above-mentioned terminal of the user who concluded a monitoring contract with regard to the software and/or the hardware installed in the terminal is transferred from a side of the above-mentioned terminal to a node of a partner of the monitoring contract via a network in real time during utilization of the above-mentioned software and/or hardware and a fee is paid by the above-mentioned partner of the contract to the user providing the above-mentioned utilization information, when predetermined conditions on monitoring are satisfied.

In the present invention, the utilization information with regard to software and/or hardware in a terminal of the user who concluded a monitoring contract with regard to the above-mentioned software and/or hardware installed in the above-mentioned terminal is stored in storing means of the above-mentioned terminal and transferred from the above-mentioned terminal to a node of a partner of the monitoring contract via a network at a predetermined timing in using the above-mentioned software and/or hardware. And in the present invention, a configuration is acceptable that the compensation is paid by the above-mentioned partner of the contract with respect to the user for providing the above-mentioned utilization information when a predetermined condition with regard to the monitoring is satisfied.

And, in the present invention, the above-mentioned user concludes a contract on monitoring by accessing to a predetermined home page set up by the partner of the monitoring contract and choosing the software and/or hardware as an object of the monitoring contract, the monitoring period and the method of monitoring.

Further, the present invention provides a totally novel business model, in which the above-mentioned partner of the contract consists of a maker providing the above-mentioned software and/or hardware and the above-mentioned maker purchases the utilization information of the terminal of the above-mentioned user. Or the present invention provides a business model, in which the above-mentioned partner of the contract consists of an information buyer who purchases the utilization information of the above-mentioned user via a network and sells the information to the others, for example, makers or the third party.

Furthermore, a configuration is acceptable that the user purchases the software or the hardware on line and concurrently concludes contract of monitoring for obtaining a reward with respect to the above-mentioned monitoring contract.

### BRIEF DESCRIPTION OF THE DRAWINGS

FIG. 1 is a diagram for showing a system configuration of a first embodiment of the present invention;

FIG. 2 is a flowchart for showing a procedure of the first embodiment of the present invention;

FIG. 3 is a diagram for showing an example of a screen indicating a monitoring contract in the first embodiment of the present invention;

FIG. 4 is a diagram for showing a system configuration of a second embodiment of the present invention;

FIG. 5 is a flowchart for showing a procedure of a second embodiment of the present invention;

FIG. 6 is a flowchart for showing a procedure of a third embodiment of the present invention;

FIG. 7 is a flowchart for showing a procedure of a fourth embodiment of the present invention; and

FIG. 8 is a diagram for showing a configuration of a conventional monitoring system.

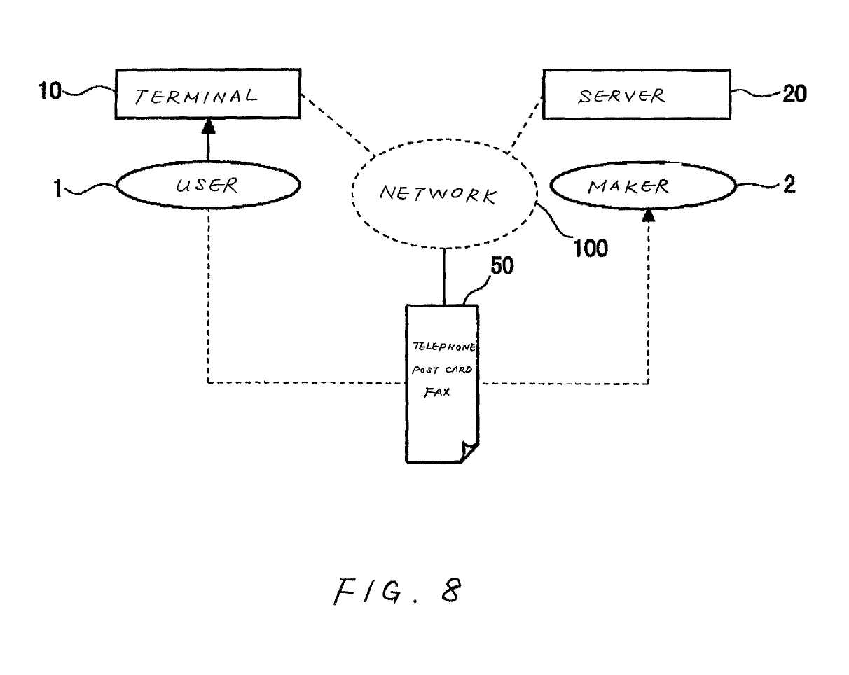

### DETAILED DESCRIPTION OF THE PREFERRED EMBODIMENTS

Hereinafter, preferred embodiments of the present invention are described more particularly. In the present invention, the utilization information with regard to the status how the above-mentioned users utilize the software and/or hardware installed in terminals which are connectable to the network such as the Internet and the like is purchased by providers of the software and/or hardware (the makers who developed and soled the software and/or hardware) or the third party to sell the information to the others.

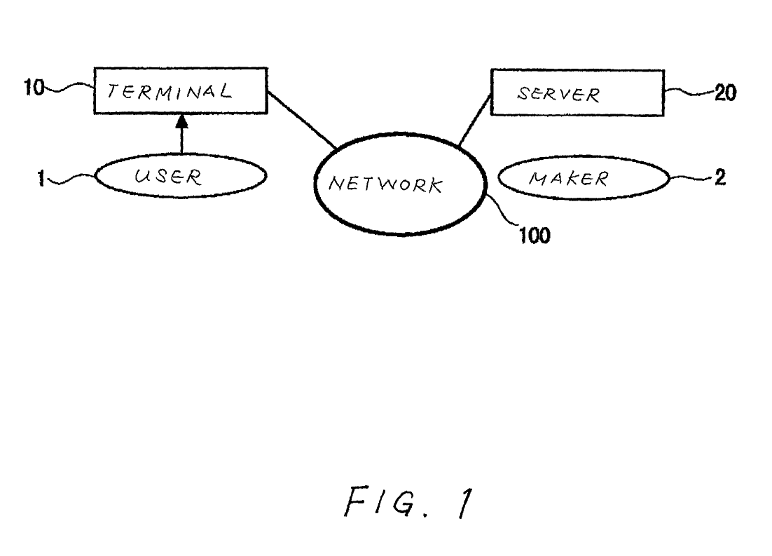

Referring to FIG. 1, in a preferred embodiment of the present invention, a user 1 concludes a monitoring contract with regard to the software or the hardware with a maker 2 in advance and transmits concrete and detailed utilization information how the user 1 utilizes the designated software and/or hardware installed in a terminal 10 to a server 20 of the maker 2 via a network 100 while the user 1 is utilizing the software and/or hardware, preferably in real time.

The maker 2 pays a fee with respect to the user 1 in return for the utilization information provided by the user 1 according to the monitoring contract.

The present invention is extremely effective as a business model for obtaining feedback information with regard to usage patterns of the products, in which makers can obtain accurate utilization status of users in detail which can be reflected in planning, development, maintenance and the like of the products while users can earn the compensation without spending much effort and labor to answer the monitoring by accessing the home page of the maker or notifying the results by postcards, FAX and the like.

Methods relating to the present invention include each of procedures (steps) mentioned below in the preferred embodiment.

Step 1: A user accesses to a predetermined home page set up by a partner of contract from the user's terminal connected to a network and concludes a monitoring contract with regard to the software and/or hardware installed in the above-mentioned terminal.

Step 2: After conclusion of the contract, the utilization information with regard to the software and/or hardware designated as an object of the monitoring contract in the user's terminal is automatically transferred from the above-mentioned terminal to a predetermined node of the partner of the monitoring contract via the above-mentioned network in real time during utilization of the above-mentioned software and/or hardware by a control program for monitoring accompanying the contract delivered from the above-mentioned partner of contract and equipped in the above-mentioned terminal.

Step 3: A compensation is paid with respect to the above-mentioned user of the terminal providing the above-mentioned utilization information by the above-mentioned partner of contract at the time of satisfying the predetermined conditions with regard to the monitoring such as the completion of monitoring and the like.

In other way of the step 2, it is also acceptable that the utilization information with regard to the software and/or hardware is stored in a storing portion of the above-mentioned terminal by the control program equipped in the above-mentioned terminal when the software and/or hardware designated as an object of the monitoring contract in the users terminal is used after conclusion of the contract, and the above-mentioned stored utilization information are lumped together and automatically transferred from the above-mentioned terminal to the predetermined node of the partner of the monitoring contract via the above-mentioned network at the time when the above-mentioned terminal is connected to the network or at a predetermined timing.

In other way, it is acceptable that the user purchases the software and/or hardware installed in the above-mentioned terminal and concludes the monitoring contract with regard to the software and/or hardware by accessing to the predetermined home page set up by products suppliers such as makers of the software and/or hardware and the like from the user's terminal connected to the network as mentioned in the step 1.

In an embodiment of the present invention, controls of the present invention can be conducted by executing programs loaded in a main memory and the like of a computer composing a terminal from a recording medium {including a communications medium, a CD-ROM, an FD (floppy disc), an HDD (hard disc), an MT (magnetic tape), a DVD (digital versatile disk), semiconductor memory and the like} storing the control program for performing the process of transferring the utilization information with regard to the software and/or hardware from the above-mentioned terminal to the node of the partner of the monitoring contract via network in real time during utilization of the above-mentioned software and/or hardware.

Further, controls of the present invention can be conducted by executing programs loaded in a main memory and the like of a computer composing the terminal from a recording medium {including a communications medium, a CD-ROM, an FD (floppy disc), an HDD (hard disc), an MT (magnetic tape), a DVD (digital versatile disk), semiconductor memory and the like} storing the control program for performing the process of storing the utilization information with regard to the above-mentioned software and/or hardware in storing means of the above-mentioned terminal during utilization of the above-mentioned software and/or hardware and the process of transferring the utilization information with regard to the software and/or hardware stored in storing means of the above-mentioned terminal from the above-mentioned terminal to the node of the partner of the monitoring contract via network at a predetermined timing.

### EXAMPLES

Referring now to the drawings, preferred examples of the present invention are described as follows. FIG. 1 is a diagram for showing a configuration of an example of the present invention. As shown in FIG. 1, an example of on-line real-time monitoring system of the present invention has a configuration providing a terminal 10 of a user 1, a server 20 of a maker 2, a communications network 100 as the Internet and the like for connecting the above-mentioned terminal 10 and the above-mentioned server 20 therein. It is to be understood that any product suppliers, for example, the above-mentioned manufactures are also acceptable as the maker and it is not intended to be limited to a specific maker.

The terminal 10 of the user 1 comprises information processing equipments such as a personal computer, a notebook computer, a portable information terminal and the like connectable to a network. A program for transferring concrete and detailed utilization information of the software or the hardware utilized under monitoring contract concluded between the user 1 and the maker 2 to the server 20 of the maker 2 via the network 100 is installed in the terminal 10 of the user 1.

The utilization information comprises information with regard to the software or the hardware used by the user 1 under the monitoring contract desired by the maker 2 for grasping the utilization status, for example, which functions in the software or the hardware are mostly used by the user 1 and the like. That is, the utilization information is concrete and detailed information with regard to the overall operations when, which operation and how the user 1 performs and the like, for example, operations of buttons (icons on the screen), input of texts, a date and time of execution of the above-mentioned operations and the like are included. And an access status to the controller may be included, as well.

The server 20 of the maker 2 is used by the maker 2 and comprises a workstation, an information processing equipment based on a personal computer as a server machine.

The server 20 of the maker 2 provides; a function for receiving and storing the utilization information of the software or the hardware transmitted from the terminal 10 of the user 1,

a function for indicating the information transmitted from the user 1 upon request of the maker 2,

a function for outputting the notification that the maker 2 pays the monitoring fee according to the monitoring contract concluded between the user 1 and the maker 2 and

a function for performing a cancellation of the monitoring contract concluded with the user 1.

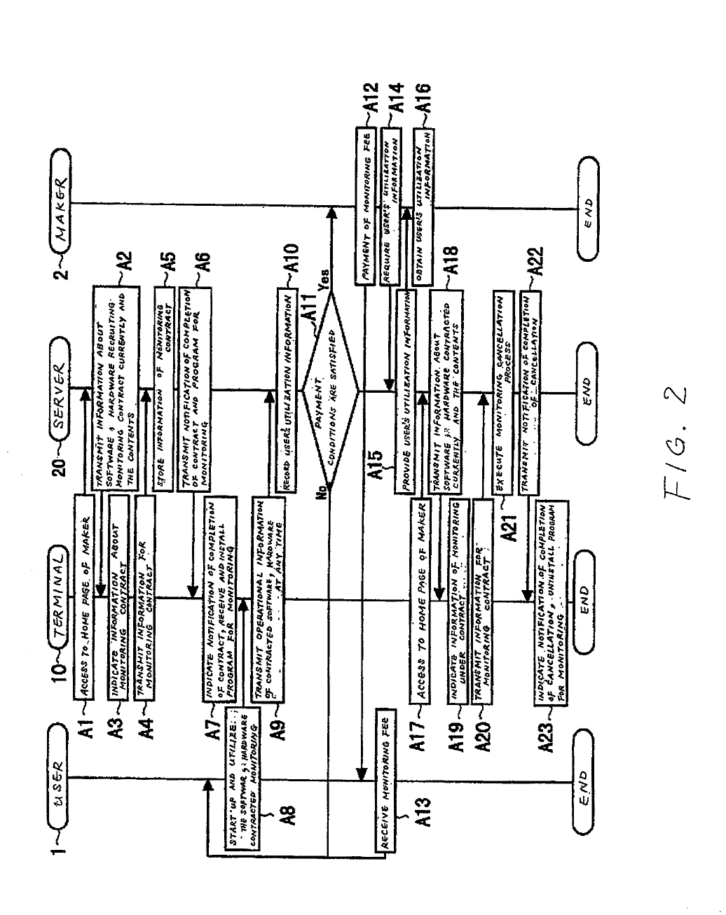

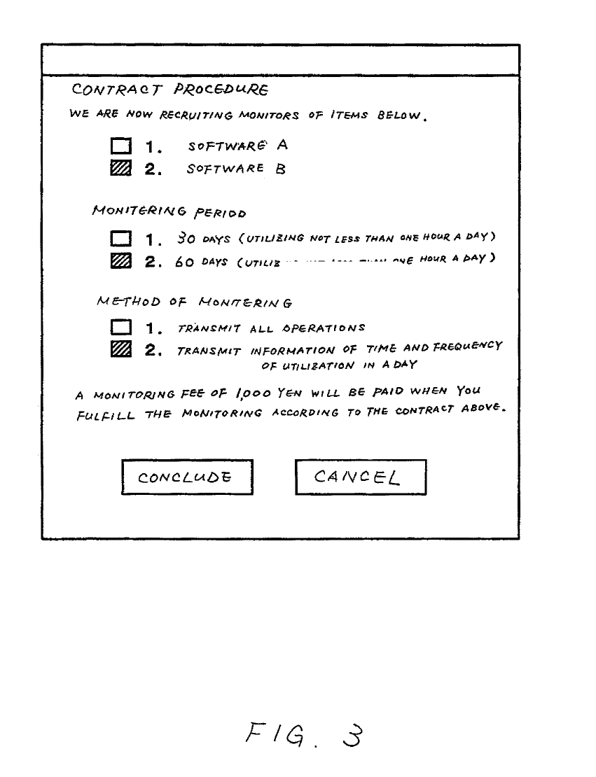

Next, an operation of the present example is described in detail. Here, the network 100 assumed to be the Internet. FIG. 2 is a flowchart for illustrating the processing operations of an example of the present invention. And FIG. 3 is a diagram for schematically showing an example of a screen for indicating the monitoring contract on a browser of the user's terminal.

Referring to FIG. 2, the user 1 accesses to a home page set up by the maker 2 in the server 20 on the Internet 100 via the terminal 10 (Step A1). In response to the access, the server 20 of the maker 2 transmits information about monitors recruited currently (Step A2).

The information about the monitors recruited currently as shown in FIG. 3 is indicated in the terminal 10 (Step A3).

After confirming the contents of the contract, the user 1 inputs required information for the contract such as

names of the software or the hardware provided for the user to perform the monitoring,

period of the monitoring,

methods of monitoring (transmission of overall operation, utilizing frequency and information such as utilizing time in one usage) and the like. When the user finds no problem in the contents, the user performs a registration of monitoring by clicking an icon of [conclusion] for transmitting to the server 20 (Step A4). On the screen shown in FIG. 3, it is indicated that the fee of 1000 yen is paid to the user at the end of monitoring.

Processes for storing the registration information of monitoring and the like are executed in the server 20 (Step AS).

In the event of normal processing the registration information in the server 20, the completion of contract is notified to the terminal 10 and a program required by the terminal 10 for performing the monitoring is transmitted with respect to the terminal 10 (Step A6).

At the time when the user 1 procures the notification of the completion of contract by receiving the program (a control program) required for monitoring from the server 20, the program is equipped (installed) in the terminal 10.

When the user 1 starts up or utilizes the software or the hardware available under the monitoring contract according to the above-mentioned procedures of A1 through A7 (Step A8), the information with regard to the operations of the above-mentioned software and hardware (utilization information) is transmitted to the server 20 of the maker 2 via the network 100 by the program installed in the terminal 10 at the Step A7 (Step A9). At the time, the program installed in the terminal 10 transmits the utilization information accompanied with identifying information (an address of the terminal and the like) of the terminal 10 and identifying information of the software or the hardware which are designated as the objects of the monitoring contract to the server 20.

In the server 20 of the maker 2, the information transmitted from the terminal 10 of the user 1 via the network at the Step A9 is received and recorded (Step A10).

In the event that the status of the monitoring contract is confirmed and assumed to be sufficient for the condition to pay the monitoring fee with respect to the user 1, the server 20 advises the maker 2 to pay the monitoring fee by an electric mail and the like (Step A11). In conditions of payment of the monitoring fee, for example, payment fixed at the time when the user completes the monitoring period is included.

The maker 2 performs the payment of the monitoring fee to the user 1 after receiving the advice from the server 20 (Step A12). Incidentally, offering points for obtaining a special privilege can be acceptable as a compensation for the monitoring other than the fee.

The user 1 obtains the fee paid by the server 20 (Step A13). After a first payment, every time when the user 1 starts up and utilizes the software or the hardware available under the monitoring contract, the user 1 transmits the utilization information and receives the fee according to the steps 8 through 13.

On the other hand, the maker 2 requests the utilization information transmitted from the user 1 and stored in the server 20 with respect to the server 20 (Step A 4).

The server 20 provides the information collected on request of the maker 2 to the maker 2 (Step A15).

The maker 2 procures the information provided by the server 20 (Step A16).

And the user 1 can cancel the monitoring contract by a procedure mentioned below.

Firstly, the user 1 accesses to the home page set up by the server 20 on the Internet 100 via the terminal 10 (Step A17).

The server 20 transmits the information of the software or the hardware available under the monitoring contract concluded between the user 1 and the maker 2 currently to the terminal 10 of the user 1 (Step A18).

The information of monitoring contracted currently is indicated in the terminal 10 (Step A19).

After confirming the contents of the contract and inputting the names of the software or the hardware available under the contract which is an object of the cancellation and other information required for the contract, the user 1 transmits the above-mentioned information to the server 20 and performs the cancellation of the monitoring (Step A20)

The server 20 executes required processes such as storages of information of the cancellation of the monitoring and the like transmitted from the terminal 10 (Step A21).

In the event of a normal process, a notification of completion of the cancellation is transmitted to the terminal 10 (Step A22).

When the notification of the completion of the cancellation is received, a deletion (un-installation) of the program required for the monitoring installed at the Step A7 is performed (Step A23).

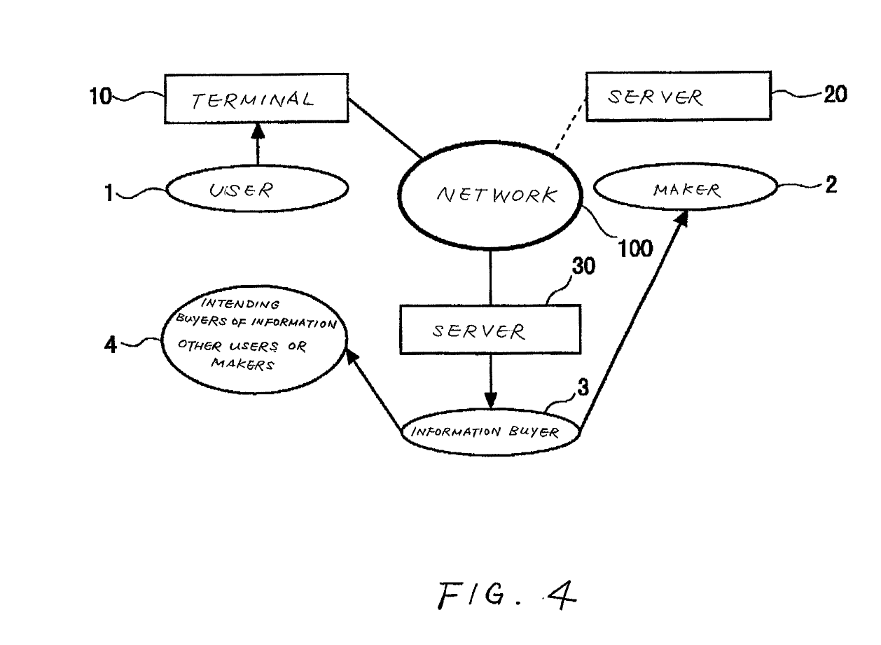

Next, a second example of the present invention is described in detail, referring to the drawings. FIG. 4 is a diagram for showing a configuration of the second example of the present invention. Referring to FIG. 4, the second example of the present invention is different from the above-mentioned first example in that an information buyer 3 obtains the user's utilization information by using a server 30 of the information buyer 3 instead of that the maker 2 obtains detailed information with regard to the software or the hardware from the user 1 and sells the results to intending buyers of the information 4 such as maker 2, other users or makers and the like.

Therefore, after the monitoring contract with regard to the software or the hardware for monitoring is concluded between the user 1 and the information buyer 3, the information is transmitted from the terminal 10 to the server 30 of the information buyer 3 instead of the server 20 of the maker 2.

The information buyer 3 pays a price in return to obtaining the information from the user 1. The information buyer 3 establishes a business by selling the information obtained by the above-mentioned process not only to the maker 2 who develops and sells the software or the hardware but also to the third party of the intending buyers of the information 4 such as other users or makers and the like.

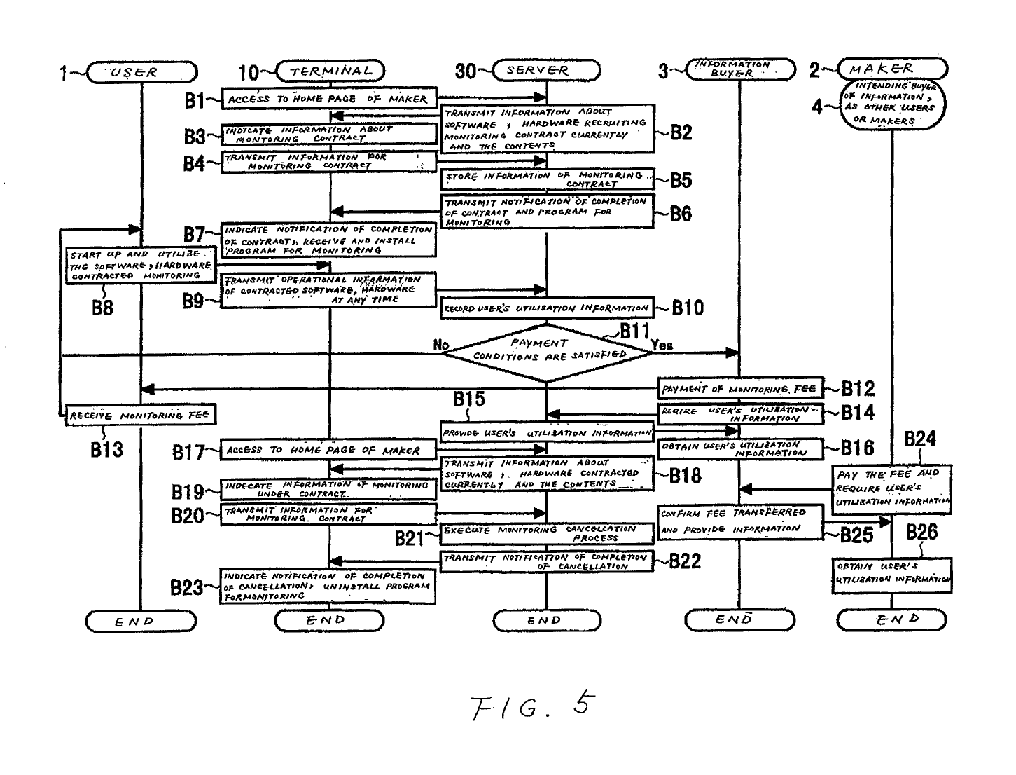

Next, an operation of the second example of the present invention is described. FIG. 5 is a flowchart for illustrating the operation of the second example of the present invention. Referring to FIG. 5, flow of the overall process of the second example of the present invention is basically similar to the above-mentioned first example of the present invention except for that the server 20 of the maker 2 in the above-mentioned first example is replaced with the server 30 of the information buyer 3. That is, the steps B1 through B23 and the like in FIG. 5 are basically similar to the steps A1 through A23 in process except for the replacement by the information buyer 3 and the server 30. Accordingly, descriptions of the above-mentioned steps in FIG. 5 are abbreviated.

The information obtained by the information buyer 3 is available for the maker 2 who develops and sells the software or the hardware and the intending buyer of the information such as other users of makers and the like to purchase.

The intending buyer of the information 4 demands the information with respect to the information buyer 3 holding the utilization information obtained from the user by paying the fee in return (Step B24).

The information buyer 3 provides own information based on the demand after confirming the reception of the price.

Thus, the maker 2 or the intending buyer of the information 4 obtains the information from the information buyer 3 (Step B26).

As it has been mentioned above, other makers or the users can have opportunities to obtain the information and share the detailed information with regard to the software or the hardware by the information buyer buying the information instead of the maker of the software or the hardware, in the second example of the present invention.

And the information buyer can create a new business by purchasing the utilization information from the users and selling the obtained information to the third party.

Next, a third example of the present invention is described in detail, referring to FIG. 3. The third example of the present invention is different from the above-mentioned first example in a point that the user 1 applies for the monitoring contract concurrently with purchasing the software or the hardware from the maker 2.

The user 1 applies for the monitoring contract concurrently with purchasing the software or the hardware on line from the home page on the Internet provided by the maker 2 or purchasing by download of the software instead of concluding the monitoring contract after using the software or the hardware by purchasing previously. Accordingly, the price paid by the user 1 in purchasing the software or the hardware is saved lower.

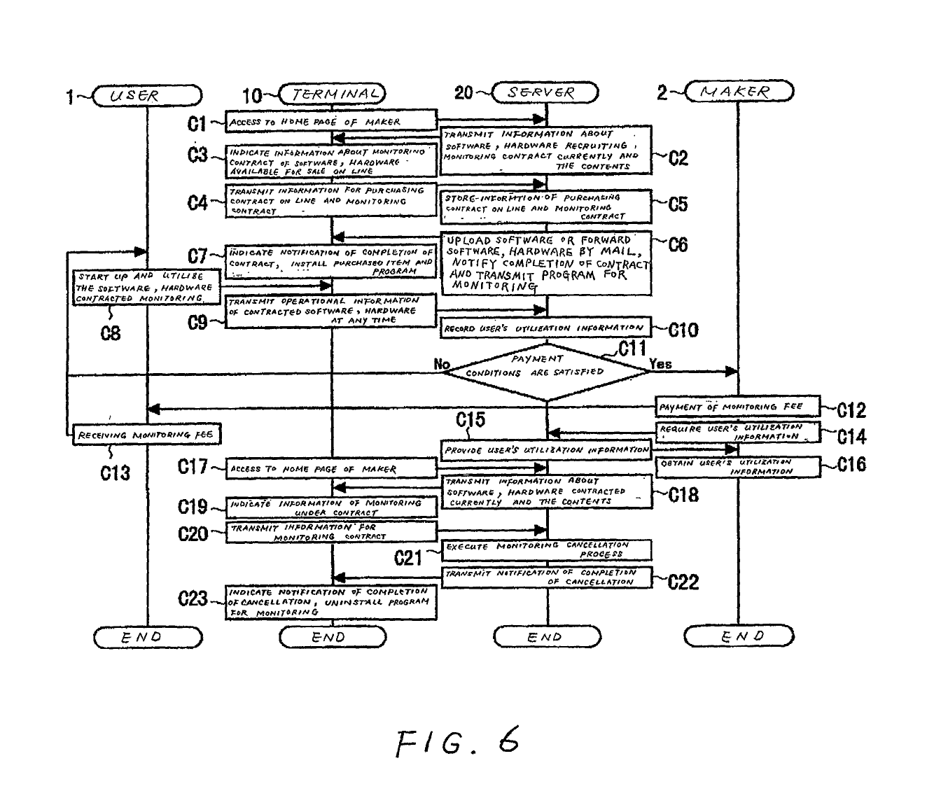

And next, an operation of the third example is described. FIG. 6 is a flowchart for showing a procedure of the third example of the present invention.

Referring to FIG. 6, the user 1 accesses the home page set up by the maker 2 on the Internet 100 via the terminal 10 (Step C1).

Responding to the access, the server 20 of the maker 2 transmits information about the software or the hardware of which the maker 2 is currently selling on line and recruiting monitors to the terminal 10 of the user 1 (Step C2).

Then, the information of the software or the hardware available for purchasing on line and monitoring is indicated (Step C3).

The user 1 performs a purchasing contract of a product concurrently with a registration of the monitoring by inputting the name of the software or the hardware on which the user 1 wants to monitor concurrent with purchasing and other information required for the contract and transmitting the same to the server 20 after confirming the contents of the online sales and the monitoring contract (Step C4).

In the server 20, the purchasing contract of the product and the information of the monitoring registration transmitted from the terminal 10 are put under a storing process and the like (Step C5).

In the event of normal process, the server 20 performs a notification of completion of contract to the terminal 10 concurrently with transmitting the program required for download of the software, process of forwarding the software or the hardware purchased by the user 1 by mail and the monitoring (Step C6).

In the terminal 10, the notification of completion of the contract is received and the purchased software or the hardware is equipped concurrently with reception and equipment of the program required for the monitoring.

The procedures (Steps C8 through C22) after the above-mentioned steps are similar to the steps A8 through A22 and the descriptions are abbreviated.

As it has been described above, in the third example of the present invention, it is possible for the user to save the price for purchasing the software or the hardware in exchange for monitoring by purchasing the software or the hardware and performing the monitoring contract in one step.

Next, a fourth example of the present invention is described, referring to the drawings. In the fourth example of the present invention, the terminal 10 of the user 1 records detailed information at using the software or the hardware in real time and transmits the recorded information with respect to the server 20 in a regular timing.

The detailed utilization information of the software or the hardware is stored in storing means in the terminal 10 of the user 1 in the event of connecting to the Internet and the utilization information stored in storing means are lumped together and transmitted to the server 20 when the terminal 10 is connected to the Internet.

In the fourth example of the present invention, the user 1 has no need to access to the Internet all the time and can lower costs required for connecting to the Internet for utilizing the system of the present invention.

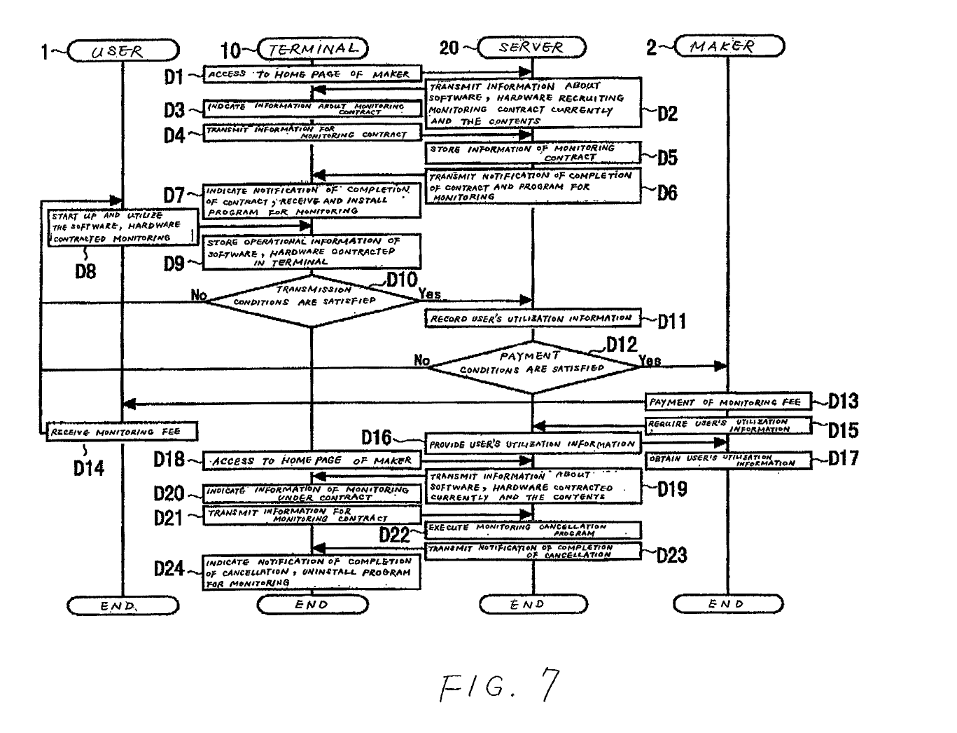

Next, operations of the fourth example of the present invention are described. FIG. 7 is a flowchart for showing the procedures of the fourth example of the present invention.

Referring to FIG. 7, the operations (steps D1 through D7) down to the registration of monitoring are similar to the steps A1 through A7 of the above-mentioned first example.

When the user 1 utilizes the software or the hardware which the user 1 concluded the monitoring contract (Step D8), the information with regard to the operations of the software or the hardware is stored in storing means of the terminal 10 by the program installed at step 7 (Step D9).

When a condition (e.g. when the terminal 10 is connected to the Internet) for transmit the information stored in storing means to the server 20 of the maker 2 via the network 100 is satisfied (Step D10), the data stored in storing means of the terminal 10 are lumped together and transmitted to the server 20 to be stored therein (Step D11).

In the above-mentioned event, the program installed in the terminal 10 confirms whether the condition for transmitting the data to the server 20 is satisfied without requiring the user 1 to utilize the software or the hardware which the user 1 concluded the monitoring contract.

The procedures (Steps D12 through D24) after the above-mentioned steps are similar to the steps A11 through A22 and the descriptions are abbreviated.

As it has been mentioned above, in the fourth example of the present invention, the present monitoring system can be utilized without connecting the terminal of the user to the Internet.

The contents of the drawings referred in each of the above-mentioned examples are provided for illustrating the present invention explanatorily, not for limiting the present invention. Accordingly, it is to be understood that any and all variations or modifications which may occur to those skilled in the art within the scope of the following claims should be included in the present invention.

As it has been described above, effects mentioned below are provided according to the present invention.

A first effect of the present invention is that the maker may obtain concrete information which is important for planning, developing and maintaining the software or the hardware such as usability and the like at the time when users utilizes the software or the hardware by purchasing the detailed information with regard to the software or the hardware from users.

A second effect of the present invention is that the users may create a business by offering detailed information of the software or the hardware which the users bought. Accordingly, the users may take advantages of reducing the purchasing cost of the software or the hardware and the like.

A third effect of the present invention is that the users are relieved of works in the conventional monitoring operation such as answering a questionnaire and the like, because the information is transmitted to the maker side without notification of monitoring results from the users to the maker.

What is claimed is:

1. A method of on-line real-time monitoring business,
wherein utilization information with regard to software and/or hardware in a terminal of a user who concluded a monitoring contract with regard to said software and/or the hardware installed in said terminal is automatically transferred from said terminal to a predetermined node of a partner of the monitoring contract via a network in real time during utilization of said software and/or the hardware
and wherein said utilization information is available for sale.

2. The method of on-line real-time monitoring business as claimed in claim 1,
wherein said utilization information with regard to the software and/or the hardware is transferred from said terminal to a predetermined node of a partner of the monitoring contract via a network in real time during utilization of said software and/or the hardware by a program for control of the monitoring accompanying with said monitoring contract installed in said terminal.

3. The method of on-line real-time monitoring business, as claimed in claim 1,
wherein the utilization information with regard to software and/or hardware in said terminal of a user who concluded a monitoring contract with regard to said software and/or the hardware installed in said terminal is stored in storing means of said terminal during utilization of said software and/or the hardware,
and wherein said utilization information stored in the storing means of said terminal is transferred from said terminal to the predetermined node of the partner of the contract via the network at a predetermined timing and said utilization information transferred via the network is available for sale.

4. The method of on-line real-time monitoring business as claimed in claim 3,
wherein said utilization information with regard to the software and/or the hardware is stored in storing means of said terminal during utilization of said software and/or the hardware and transferred from said terminal to a predetermined node of a partner of the monitoring contract via a network at the predetermined timing.

5. The method of on-line real-time monitoring business as claimed in at least one of claims 1 through 4,
wherein a fee as a compensation is paid by said partner of the contract with respect to the user providing said utilization information when predetermined conditions with regard to the monitoring are satisfied.

6. The method of on-line real-time monitoring business as claimed in at least one of claims 1 through 5,
wherein said user accesses to a predetermined home page set up on a server by the partner of the monitoring contract from said terminal and concludes the monitoring contract by choosing at least one item as an object of monitoring contract among the software and/or the hardware installed in said terminal, a monitoring period and methods of monitoring on a screen of a display device of said terminal.

7. The method of on-line real-time monitoring business as claimed in at least one of claims 1 through 6,
wherein said partner of the contract comprises a maker and said information buyer purchases the utilization information of said user via the network to sell to third parties.

8. The method of on-line real-time monitoring business as claimed in at least one of claims 1 through 6,
wherein said partner of the contract comprises an information buyer and the information buyer purchases the utilization information of said user via the network to sell to the third parties.

9. The method of on-line real-time monitoring business as claimed in at least one of claims 1 through 6,
wherein the user performs conclusion the monitoring contract concurrently with purchase of the software or hardware on line and obtains reword with respect to said monitoring contract.

10. A method of monitoring comprising;
a step of concluding a monitoring contract with regard to software and/or hardware installed in a terminal by accessing a predetermined home page set up on a server by a partner of the contract from said terminal connectable to a network of a user and
a step of transferring utilization information with regard to the software and/or the hardware designated as objects of the monitoring contract in the terminal of said user is automatically from said terminal to a server of the partner of the monitoring contract via the network in real time during utilization of said software and/or said hardware by a control program accompanying with said monitoring contract delivered by said partner of the contract and installed in said terminal.

11. A method of monitoring comprising;
a step of concluding a monitoring contract with regard to software and/or hardware installed in a terminal by accessing a predetermined home page set up on a server by a partner of the contract from said terminal connectable to a network of a user,
a step of storing the utilization information of said software and/or said hardware in a storing portion of said terminal during utilization of the software and/or the hardware designated as objects of the monitoring contract in the terminal of the user by the control program accompanying with the monitoring contract installed in said terminal and
a step of transferring said stored utilization information lumped together automatically from said terminal to the server of the partner of the monitoring contract via said network when said terminal is connected to the network or at a predetermined timing.

12. The method of monitoring as claimed in claims 10 or 11 further comprising;
a step of notifying said partner of the contract that said user of the terminal providing said utilization information satisfies predetermined conditions with regard to the monitoring when the state is recognized in said server for receiving said utilization information and performing a payment of a fee with respect to said user as a compensation for monitoring from said partner of the contract.

13. The method of monitoring as claimed in at least one of claims 10 through 12,
wherein said partner of the contract comprises a maker providing said software and/or said hardware and
wherein said maker obtains said utilization information from the terminal of said user and pays said user a compensation for said utilization information obtained from said user.

14. The method of monitoring as claimed in at least one of claims 10 through 12,
wherein said partner of the contract comprises an information buyer and
wherein said information buyer obtains and holds the utilization information of said software and/or said hardware in said terminal of said user and sells said obtained utilization information to third parties.

15. A method of monitoring comprising;
a step of purchasing software and/or hardware installed in said terminal and concluding a monitoring contract with regard to the software and/or the hardware by accessing to a home page set up on a server by a product supplier of the software and/or the hardware from a terminal connectable to a network of a user and
a step of transferring utilization information with regard to the software and/or the hardware designated as objects of the monitoring contract in the terminal of the user automatically from said terminal to a predetermined server of the product supplier via a network in real time during utilization of said software and/or said hardware by a control program accompanying with said monitoring contract delivered by said product supplier installed in said terminal, after concluding the contract,
wherein payment of a fee with respect to said user of the terminal providing said utilization information is performed by said product supplier when predetermined conditions with regard to the monitoring are satisfied.

16. A method of monitoring comprising;
a step of purchasing software and/or hardware installed in said terminal and concluding a monitoring contract with regard to the software and/or the hardware by accessing to a home page set up on a server by a product supplier of the software and/or the hardware from a terminal connectable to a network of a user,
a step of storing the utilization information of said software and/or said hardware in a storing portion of said terminal by a control program accompanying with said monitoring contract delivered by said product supplier installed in said terminal during utilization of the software and/or the hardware designated as objects of the monitoring contract in the terminal of said user and
a step of transferring said stored utilization information from said terminal to the predetermined server of said product supplier via said network at a predetermined timing including the time when said terminal is connected to the network,
wherein payment of a fee with respect to said user of the terminal providing said utilization information is performed by said product supplier when predetermined conditions with regard to the monitoring are satisfied.

17. The method of monitoring as claimed at least one in claims 10 through 16,
wherein the transference of the utilization information with regard to said software and/or said hardware in said terminal to said server is stopped when said user cancels the monitoring contract with regard to said software and/or said hardware.

18. The method of monitoring as claimed at least one in claims 10, 11, 15, and 16,
wherein said control program for controlling the monitoring is uninstalled in said terminal when said user cancels the monitoring contract with regard to said software and/or hardware.

19. A system of on-line real-time monitoring for monitoring utilization information of software and/or hardware in a user's terminal connectable to a network,
wherein control means for transmitting the utilization information with regard to the software and/or the hardware on which the user concluded a monitoring contract with a partner of the contract with regard to said software and/or said hardware installed in the terminal via the network from said terminal to a predetermined node of the partner of the monitoring contract via network during utilization of said software and/or said hardware is provided.

20. A system of on-line real-time monitoring for monitoring utilization information of software and/or hardware in a user's terminal connectable to a network,
wherein storing means for storing the utilization information with regard to the software and/or the hardware on which the user concluded a monitoring contract with a partner of the contract with regard to said software and/or said hardware installed in the terminal via the network from said terminal to a predetermined node of the partner of the monitoring contract via network during utilization of said software and/or said hardware in said terminal and
means for transferring the stored information in storing means of said terminal from said terminal to the predetermined node of the partner of the contract via the network at a predetermined timing are provided.

21. An information processing equipment connected to a network comprising means for transferring utilization information with regard to software and/or hardware on which a monitoring contract is concluded out of software and/or hardware installed in said information processing equipment to a predetermined node of a partner of the monitoring contract via the network automatically in real time during utilization of said software and/or said hardware.

22. An information processing equipment connected to a network comprising;
means for storing the information with regard to software and/or hardware on which a monitoring contract is concluded out of the software and/or the hardware installed in said information processing equipment in storing means during utilization of said software and/or said hardware and
means for transferring the utilization information stored in said storing means to a predetermined node of the partner of the monitoring contract via a network at a predetermined timing.

23. A recording medium provided in a user's terminal in which a monitoring contract with regard to software and/or hardware installed in the terminal is concluded, wherein a program for executing a process of transferring the utilization information with regard to said software and/or said hardware from said terminal to a predetermined node of a partner of the monitoring contract via a network in real time during utilization of said software and/or said hardware in a computer composing said terminal is recorded.

24. A recording medium provided in a user's terminal in which a monitoring contract with regard to software and/or hardware installed in the terminal is concluded, wherein a program for executing processes of;
storing the utilization information of said software and/or hardware in storing means of said terminal during utilization of said software and/or said hardware and
transferring the utilization information stored in the storing means of said terminal from said terminal to a predetermined node of a partner of the monitoring contract via a network at a predetermined timing is recorded in a computer composing said terminal.
